(19) United States
(12) Patent Application Publication
(10) Pub. No.: US 2025/0329787 A1
(43) Pub. Date: Oct. 23, 2025

(54) ELECTROLYTE COMPOSITION

(71) Applicant: FORD GLOBAL TECHNOLOGIES, LLC, Dearborn, MI (US)

(72) Inventors: Sangil HAN, Northville, MI (US); Gunho KWAK, Novi, MI (US); Keonseok OH, Novi, MI (US); Liyuan SUN, Ann Arbor, MI (US); Chi PAIK, Grosse Ile, MI (US)

(21) Appl. No.: 18/639,591

(22) Filed: Apr. 18, 2024

(51) Int. Cl. H01M 10/0568; H01M 10/0567; H01M 10/0569

(52) U.S. Cl. CPC H01M 10/0568; H01M 10/0567; H01M 10/0569; H01M 2300/0034; H01M 2300/0042

(57) ABSTRACT

A lithium-ion battery with an electrode assembly is presented. The electrode assembly has a current collector and a positive active material layer on the current collector. The electrode assembly also has an electrolyte including lithium hexafluorophosphate and lithium bis(fluorosulfonyl)imide in a ratio of 0.8M to 0.2M and a 7 wt. % fluorinated phosphazene additive dissolved in a solvent mixture of ethylene carbonate, ethyl methyl carbonate, and sulfolane in a 25/73/2 volume ratio. The electrolyte permeates a surface of the positive active material layer to suppress electrochemical oxidation of the positive active material layer.

### TECHNICAL FIELD

The disclosure relates to electrolyte compositions for lithium-ion batteries.

### BACKGROUND

In lithium-ion batteries, the electrolyte serves as a component that facilitates the transport of lithium ions during charge and discharge cycles. Typically, the electrolyte's solvent includes a mix of linear carbonate solvents combined with cyclic carbonates to achieve a desired viscosity range of approximately 3 centipoise (cP) to 10 cP. This specific viscosity range influences the battery's electrochemical performance by affecting the mobility of lithium ions within the electrolyte. Moreover, the blending of these solvents lowers the vapor pressure of the electrolyte.

### SUMMARY

In one aspect of the disclosure, an electrode assembly is presented. The electrode assembly has a current collector, an active material layer on the current collector, and an electrolyte. The electrolyte includes lithium hexafluorophosphate and lithium bis(fluorosulfonyl)imide in a ratio of 0.8M to 0.2M and a 7 wt. % fluorinated phosphazene additive all dissolved in a solvent of ethylene carbonate, ethyl methyl carbonate, and sulfolane in a 25/73/2 volume ratio. The electrolyte permeates a surface of the active material layer and suppresses electrochemical oxidation of the positive active material layer during electrochemical cycling of the active material layer. The electrolyte may also include fluoroethylene carbonate at 1 wt. %, vinylene carbonate at 0.5 wt. %, propylene sulfite at 0.5 wt. %, propylene sulfone at 0.3 wt. %, ethyl sulfate anhydride at 0.5 wt. %, or lithium difluoro(oxalato)phosphate at 1 wt. %.

In another aspect of the disclosure, a battery cell is presented. The battery cell has a negative electrode, a positive electrode, and an electrolyte. The electrolyte includes lithium hexafluorophosphate and lithium bis(fluorosulfonyl)imide in a ratio of 0.8M to 0.2M and a 7 wt. % fluorinated phosphazene additive all dissolved in a solvent mixture of ethylene carbonate, ethyl methyl carbonate, and sulfolane. The electrolyte saturates the negative and positive electrodes such that disassociated lithium ions from the lithium bis(fluorosulfonyl)imide are stabilized by complexation with fluorinated phosphazene and sulfolane molecules to mitigate electrochemical oxidation of the positive electrode surface. The electrolyte may also include fluoroethylene carbonate at 1 wt. %, vinylene carbonate at 0.5 wt. %, propylene sulfite at 0.5 wt. %, propylene sulfone at 0.3 wt. %, ethyl sulfate anhydride at 0.5 wt. %, or lithium difluoro(oxalato)phosphate at 1 wt. %.

In yet another aspect of the disclosure, a battery cell is presented. The battery cell has a negative electrode, a positive electrode, and an electrolyte. The electrolyte includes lithium hexafluorophosphate and lithium bis(fluorosulfonyl)imide and a fluorinated phosphazene additive all dissolved in a solvent of ethylene carbonate, ethyl methyl carbonate, and sulfolane. The electrolyte saturates the negative and positive electrodes such that lithium ions liberated from the lithium bis(fluorosulfonyl)imide are stabilized by solvation with fluorinated phosphazene and sulfolane molecules resulting in a direct current impedance of the battery cell, for a given state of charge, that is less than a direct current impedance of an otherwise same battery cell without the fluorinated phosphazene additive. The electrolyte may have a 0.8M to 0.2M ratio of lithium hexafluorophosphate to lithium bis(fluorosulfonyl)imide. The electrolyte may have the ethylene carbonate, ethyl methyl carbonate, and sulfolane in a 25/73/2 volume ratio. In some configurations, the electrolyte may include fluorinated phosphazene at 7 wt. %, fluoroethylene carbonate at 1 wt. %, vinylene carbonate at 0.5 wt. %, propylene sulfite at 0.5 wt. %, propylene sulfone at 0.3 wt. %, ethyl sulfate anhydride at 0.5 wt. %, or lithium difluoro(oxalato)phosphate at 1 wt. %.

### BRIEF DESCRIPTION OF THE DRAWINGS

FIG. 1A is a table of different electrolyte samples used in evaluation experiments;

FIGS. 1B-1I are figures that show performance metrics of the electrolyte samples of FIG. 1A when incorporated into battery cells;

FIGS. 1J-1K are graphs and photos of rigorous testing for the Ref, FoF2, and ESL1 electrolyte samples of FIG. 1A when incorporated into battery cells;

FIG. 2 is a schematic illustration of a battery cell according to any one or more embodiments of the disclosure; and

FIG. 3 is a schematic illustration of a battery electrode according to any one or more aspects of the disclosure.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Unless otherwise explicitly specified, all numerical values and ranges relating to quantities, measurements, percentages, weights, and similar numerical references within this document are to be understood as being preceded by the term “about.” This applies even in cases where the term “about” is not explicitly used. It is intended that all values and ranges encompass variations that may arise from standard measurement, manufacturing processes, material properties, and intended functionality of aspects of the disclosure. For example, when a composition is described as having “5 wt. % of a component,” it is to be understood as “about 5 wt. % of a component.” Furthermore, when numerical values are presented as a range, such as “100 to 200 units,” this range should be interpreted to effectively mean “about 100 to about 200 units.” Such variations are implicitly incorporated within the scope of the present disclosure.

A series of experiments were conducted to assess how various electrolyte formulations influence the performance of cells, with focus on their physical and electrochemical properties. The samples varied in their solvent blends, the amount of lithium salts, and the types and amounts of additives used. Each formulation aimed to explore how these variations affect battery performance metrics, such as viscosity, conductivity, density, internal resistance, capacity retention, swelling ratio, recovery rate, and efficiency as measured by direct current internal resistance (DCIR). Additionally, the experiments investigated the electrolytes' behavior in thermal runaway scenarios. The findings from these experiments, particularly those related to the FoF2 sample, guide the selection of an optimal electrolyte formulation for battery applications.

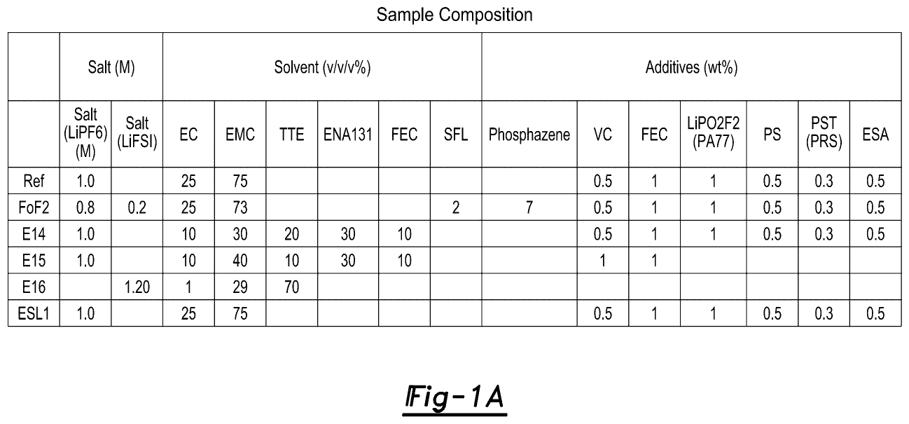

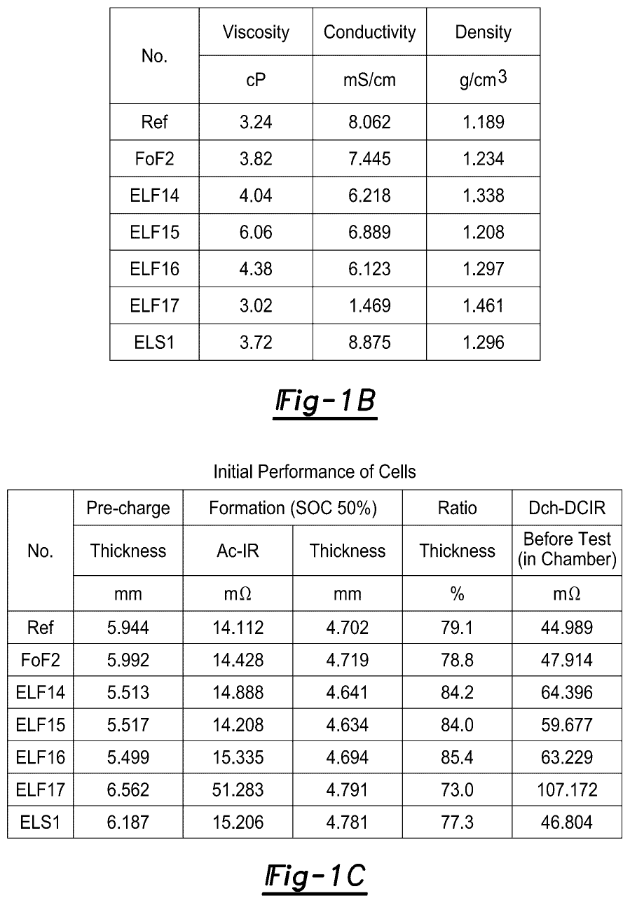

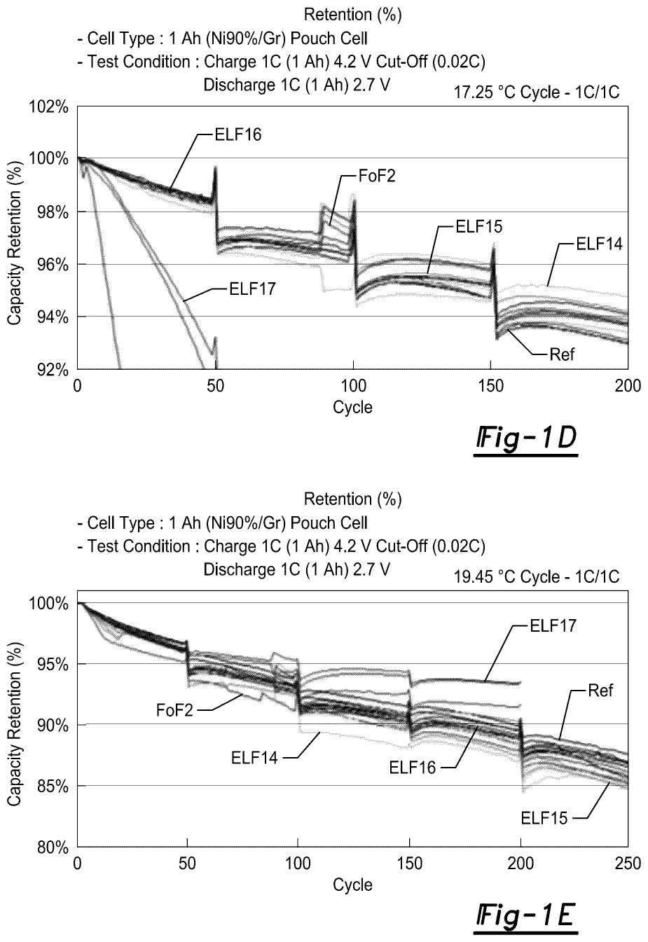

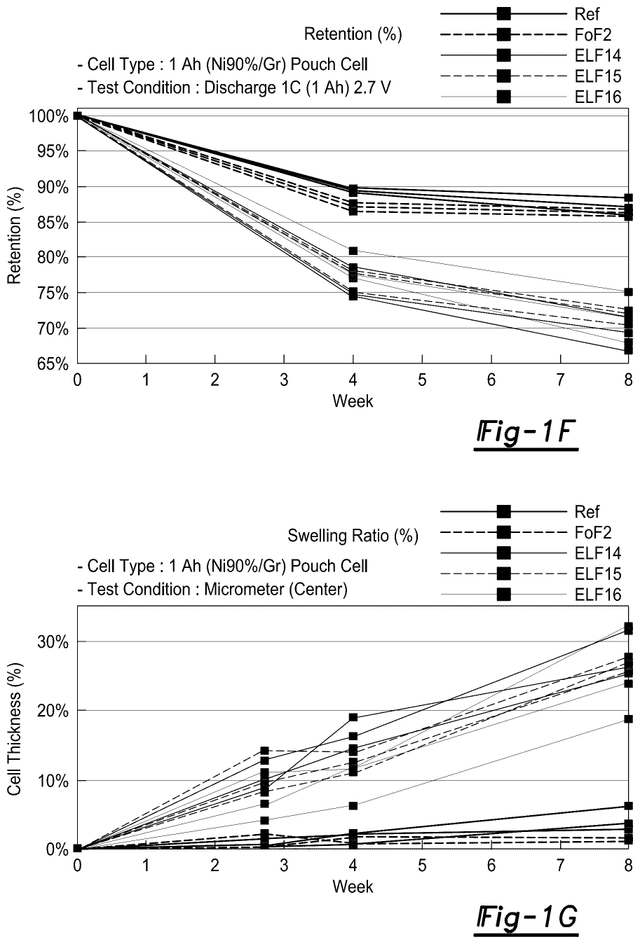

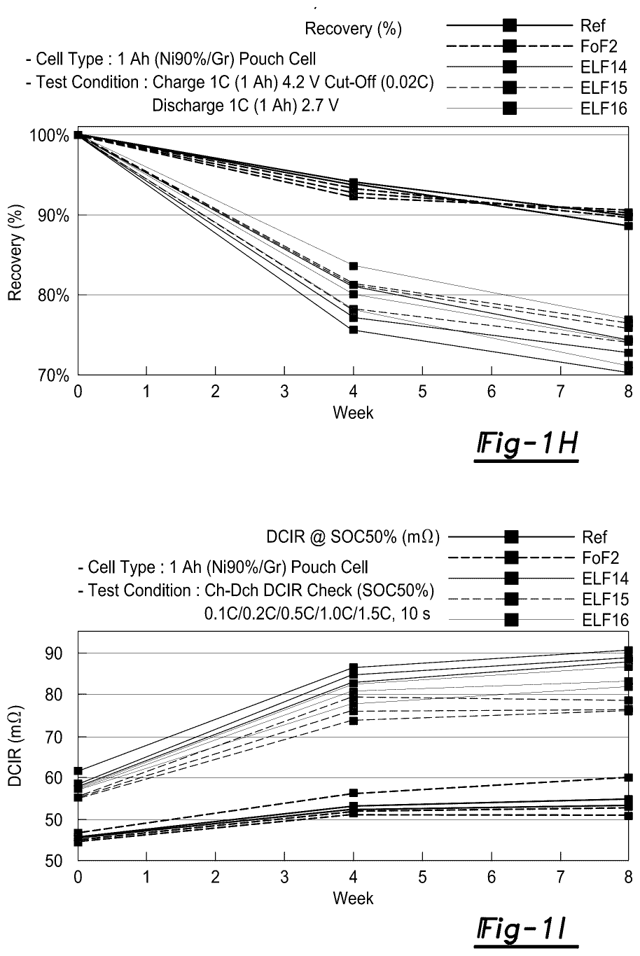

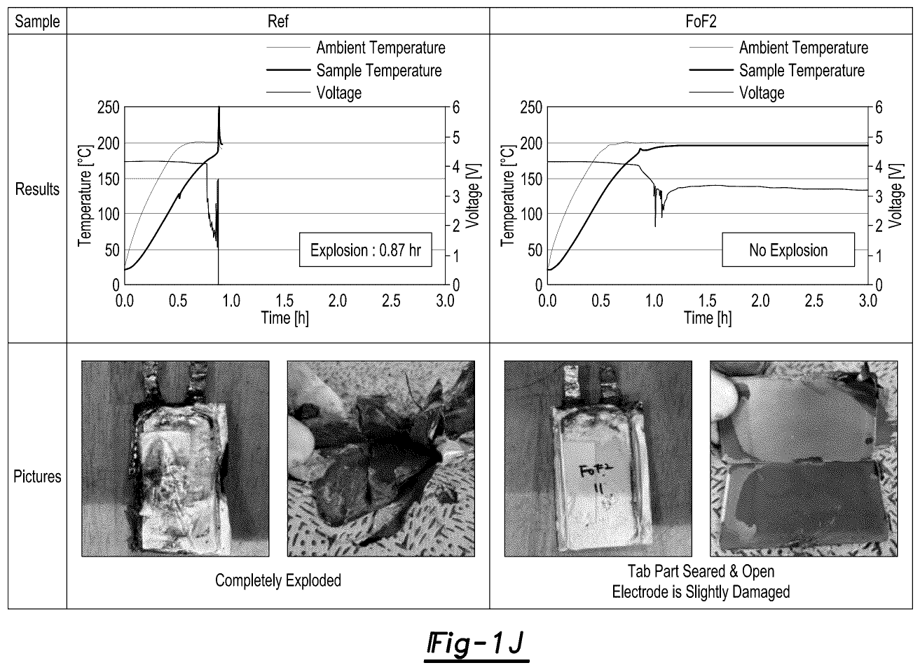

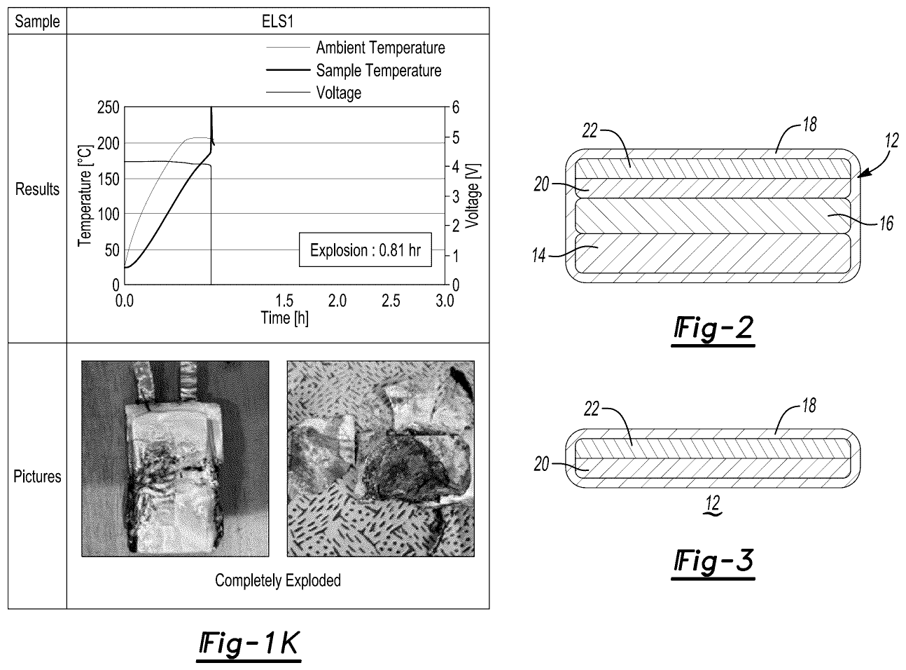

The composition of the different electrolyte samples evaluated is shown in FIG. 1A. The reference sample, labeled Ref, is composed of 1.0 M lithium hexafluorophosphate (Salt (LiPF6) (M)) as the singular salt. The solvent blend consists of a 25% ethylene carbonate (EC) and 75% ethyl methyl carbonate (EMC) mixture by volume. The additives in this formulation are 0.5 wt. % hexakis(phosphazene)polyphosphate (VC), 1 wt. % fluoroethylene carbonate (FEC), 1 wt. % lithium bis(oxalato)borate (LiPO₂F₂ (PA77)), 0.5 wt. % propylene sulfite (PS), 0.3 wt. % propylene sulfone (PST (PRT)), and 0.5 wt. % ethyl sulfate anhydride (ESA). The FoF2 sample differentiates itself from the reference by incorporating a dual salt approach: 0.8 M lithium hexafluorophosphate (Salt (LiPF6) (M)) and 0.2 M lithium bis(fluorosulfonyl)imide (Salt (LiFSI)). The solvent configuration mirrors that of the reference sample with 25% ethylene carbonate (EC), 73% ethyl methyl carbonate (EMC), and 2% sulfolane (SFL) by volume. The additive blend for FoF2 includes a 7 wt. % hexakis(phosphazene) polyphosphate (phosphazene), a 0.5 wt. % vinylene carbonate (VC), a 1 wt. % fluoroethylene carbonate (FEC), a 1 wt. % lithium bis(oxalato)borate (LiPO2F2 (PA77)), a 0.5 wt. % propylene sulfite (PS), a 0.3 wt. % propylene sulfone (PST (PRS)), and a 0.5 wt. % ethyl sulfate anhydride (ESA).

For sample E14, the sole salt is 1.0 M lithium hexafluorophosphate (Salt (LiPF6) (M)). However, the solvent mixture is adjusted to include 10% ethylene carbonate (EC) by volume, 30% ethyl methyl carbonate (EMC) by volume, 20 wt. % tris(2-methoxyethoxy)vinylsilane (TTE), 30 wt. % ENA131, and fluoroethylene carbonate (FEC) 10 wt. %. The types and amounts of additives are identical to the Ref sample. Sample E15 maintains the 1.0 M lithium hexafluorophosphate salt (Salt (LiPF6) (M)) amount and modifies the solvent composition to 10% ethylene carbonate (EC) by volume, 40% ethyl methyl carbonate by volume, and introduces 10 wt. % tris(2-methoxyethoxy)vinylsilane (TTE). It also specifies 30 wt. % ENA131, and fluoroethylene carbonate (FEC) 10 wt. %. This sample has a hexakis(phosphazene) polyphosphate content of 1 wt. %.

E16 has an increased lithium bis(fluorosulfonyl)imide (Salt (LiFSI)) amount at 1.20M, ethylene carbonate (EC) at 1% by volume, and adjusts ethyl methyl carbonate (EMC) to 29% by volume with tris(2-methoxyethoxy)vinylsilane (TTE) content of 70 wt. %. Finally, ESL1 aligns with Ref in terms of both the salt and solvent compositions, with 1.0 M lithium hexafluorophosphate (Salt (LiPF6) (M)) and 25% ethylene carbonate (EC) and 75% ethyl methyl carbonate (EMC) by volume. The additive proportions are identical to those in Ref.

FIG. 1B shows the viscosity measured in cP, conductivity measured in milliSiemens per centimeter (mS/cm), and density measured in grams per cubic centimeter (g/cm³). The Ref sample has a viscosity of 3.24 cP, a conductivity of 8.062 mS/cm, and a density of 1.189 g/cm³. FoF2 has a slightly higher viscosity than the reference at 3.82 cP, its conductivity is at 7.445 mS/cm, which is lower than the reference, and it has a slightly higher density of 1.234 g/cm³. ELF14 shows increased viscosity at 4.04 cP, lower conductivity of 6.218 mS/cm compared to the Ref, and the highest density among all listed at 1.338 g/cm³. ELF15 has a higher viscosity of 6.06 cP, a conductivity of 6.889 mS/cm, which is closer to that of FoF2, and a lower density than ELF14 at 1.208 g/cm³. ELF16 is presented with a viscosity of 4.38 cP, similar conductivity to ELF14 at 6.123 mS/cm, and a density of 1.297 g/cm³. ELF17 has the lowest viscosity at 3.02 cP and significantly lower conductivity at 1.469 mS/cm. It also has the highest density among all samples at 1.461 g/cm³. Lastly, ELS1 has a viscosity of 3.72 cP, the highest conductivity at 8.875 mS/cm, and a density similar to ELF16 at 1.296 g/cm³.

FIG. 1C is a table showing initial performance characteristics of the electrolyte samples incorporated into batteries at various stages of pre-charge and formation. The Ref sample exhibits a pre-charge electrode thickness of 5.944 millimeters (mm) and an alternating current internal resistance (AC-IR) of 14.112 milliohms (mΩ), with a notable decrease in electrode thickness to 4.702 millimeters after the formation stage, leading to a thickness ratio of 79.1%. This sample's discharge DCIR before testing in the chamber is measured at 44.989 milliohms. The sample FoF2 slightly exceeds the reference in pre-charge thickness at 5.992 millimeters and presents an AC-IR of 14.428 milliohms. Post-formation, the thickness measures 4.719 millimeters, which amounts to a 78.8% thickness ratio. Before testing, the DCIR stands at 47.914 milliohms, hinting at a slightly increased resistance compared to Ref.

ELF14 starts with a thinner pre-charge electrode at 5.513 millimeters and a higher AC-IR of 14.888 milliohms. The electrode's thickness reduces to 4.641 millimeters, representing an 84.2% thickness ratio. The DCIR before testing is observed to be 64.396 milliohms, considerably higher than Ref. Similarly, ELF15 with a pre-charge thickness of 5.517 millimeters and an AC-IR of 14.208 milliohms reduces to a 4.634-millimeter thickness post-formation, achieving an 84.0% thickness ratio. It exhibits a pre-test DCIR of 59.677 milliohms. The ELF16 sample's initial thickness is 5.499 millimeters with an AC-IR of 15.335 milliohms. The formation process leads to a thickness of 4.694 millimeters, corresponding to an 85.4% thickness ratio, with a pre-test DCIR of 63.229 milliohms, indicating a higher internal resistance. ELF17 has the thickest pre-charge electrode at 6.562 millimeters and a higher AC-IR of 51.283 milliohms. The post-formation thickness is 4.791 millimeters, yielding the lowest thickness ratio of 73.0%. Moreover, this sample's DCIR before testing is at 107.172 milliohms, which may suggest lower initial electrochemical efficiency. Lastly, ELS1 features a pre-charge thickness of 6.187 millimeters and an AC-IR of 15.206 milliohms. Following formation, the electrode thickness is 4.781 millimeters with a thickness ratio of 77.3%. The DCIR measured before testing in the chamber is 46.804 milliohms.

FIG. 1D is a graph of charge rate results of the electrolyte samples incorporated into a nickel (90%)/graphite pouch cell with a capacity of 1 Ah. The rate performance was measured in ampere-hours (Ah) across different C-rates, which are units of charge and discharge relative to the battery's capacity. The test conditions included a charge (constant current, CC) at various rates (0.1 C, 0.2 C, 0.5 C, 1.0 C, 2.0 C, 3.0 C, 5.0 C, with a cut-off at 4.2V) and a discharge (CC) at 0.5 C with a 2.7V cut-off. Overall, Ref and FoF2 have better rate performance across the tested C-rates, while ELF17 displays a lower performance at higher C-rates. This suggests that the electrolyte composition in Ref and FoF2 may be more favorable for applications requiring high rate charging and discharging.

FIGS. 1D-E shows the capacity retention of nickel (90%)/graphite pouch cells with the electrolyte samples over charge-discharge cycles at two different temperatures: 25° C. and 45° C., respectively. Capacity retention is a measure of how well a battery maintains its capacity over time, which is a parameter used for assessing the longevity of battery cells. From the 25° C. graph in FIG. 1D, it appears that all samples start with near 100% capacity retention, but there is an initial sharp drop within the first few cycles, which is common as cells stabilize. As cycling continues, the lines trend downwards, indicating a gradual loss of capacity. However, ELF17 shows a decrease in capacity, suggesting that this particular cell formulation has a shorter cycle life compared to the others. In the 45° C. graph in FIG. 1E, the overall trend shows that capacity retention decreases more rapidly with increasing temperature, indicating that higher temperatures increase the degradation process. All samples seem to experience a more pronounced capacity fade at 45° C. compared to 25° C., which is consistent with the understanding that elevated temperatures may be detrimental to battery performance.

FIG. 1F shows the capacity retention percentage of nickel (90%)/graphite pouch cells with the electrolyte samples over a period of 8 weeks under a consistent discharge condition of 1 C to a voltage cut-off of 2.7V. All samples start at or near 100% retention. As time progresses, there is a general decline in retention for all samples, which is a normal trend in battery cycling life. Ref and FoF2 show a relatively stable retention rate, indicating better longevity compared to the other samples. Across the 8-week span, Ref and FoF2 maintain a retention percentage closer to 90%, while ELF16 falls to around 70%.

FIG. 1G shows the swelling ratio of nickel (90%)/graphite pouch cells with the electrolyte samples incorporated over an eight-week period. The swelling ratio, expressed as a percentage, reflects the change in cell thickness as measured by a micrometer at the center of the cell, which is a common indicator of physical changes in battery cells during use. All the electrolyte samples start with a swelling ratio of 0% at week 0, indicating no initial change from their original thickness. As time progresses, all samples exhibit an increase in swelling, but at different rates. The Ref sample shows the least swelling over the eight weeks, maintaining a relatively flat line close to the baseline, which suggests stable physical dimensions under the test conditions. FoF2 experiences the lowest increase in swelling ratio, remaining consistently below other samples, which points to good physical stability.

FIG. 1H shows the recovery percentage of nickel (90%)/graphite pouch cells with the electrolyte samples over an eight-week period under a test condition of charging at 1 C to a 4.2V cut-off and discharging at 1 C to a 2.7V cut-off. Recovery refers to the cell's ability to regain its initial capacity after a rest period following charge-discharge cycles, which is an important indicator of a battery's endurance and longevity. Ref shows a gradual decline over the eight-week period. However, it has one of the flattest slopes among all the samples, indicating that it maintains its recovery rate relatively well. By week 8, it still retains a recovery percentage close to 90%. FoF2 follows a similar trend to Ref in the initial weeks, with a slightly steeper slope. Both Ref and FoF2 demonstrate the highest recovery rates across the samples tested, suggesting that their electrochemical stability and ability to retain capacity after cycling are better than the other samples.

FIG. 1I shows the progression of the DCIR at 50% State of Charge (SOC) for the different electrolyte samples in a 1 Ah nickel (90%)/graphite pouch cell over an eight-week period. The DCIR is measured in milliohms and is a parameter indicating the efficiency of the battery. Lower DCIR values are generally preferred as they indicate lower energy losses during operation. Ref starts with the lowest DCIR value at week 0, indicating the highest initial efficiency among the samples. Over the eight weeks, the DCIR of Ref increases slightly, but it remains the lowest compared to other samples, ending just above 50 milliohms. FoF2 begins with a DCIR value marginally higher than Ref. Throughout the eight weeks, it shows a gradual increase but maintains a similar trend to Ref, with the final DCIR value remaining notably lower than the other samples, except for Ref, ELF14, ELF15, and ELF16 all start with higher initial DCIR values compared to Ref and FoF2 and exhibit a steeper increase over time. By the eighth week, their DCIR values are significantly higher, indicating less efficiency. The DCIR values for all samples rise over the weeks, which is a typical trend as battery cells undergo charge-discharge cycles and internal components gradually degrade. The low and stable DCIR values of Ref and FoF2 throughout the testing period suggest that these two electrolyte formulations enable better battery efficiency and might degrade less over time compared to the other samples.

FIG. 1J shows a comparative analysis of thermal runaway events for Ref and FoF2 undergoing a rigorous test. For the Ref sample, the graph shows that both ambient and sample temperatures remain stable initially but then the sample temperature rapidly increases, peaking before the 1-hour mark. The sharp increase in temperature corresponds to a voltage drop, indicating a thermal runaway event leading to a terminal event after approximately 0.87 hours. In contrast, the FoF2 sample shows a temperature rise on the graph that is less than the Ref sample, and the sample temperature peaks and begins to decrease without the voltage dropping to zero, which indicates that no terminal event occurred during the test.

FIG. 1K shows an analysis of thermal runaway events for ESL1 undergoing a rigorous test. As time progresses, the ESL1 sample temperature spikes, indicating a rapid and uncontrolled increase in heat. This spike correlates with a significant drop in voltage, suggesting a terminal event occurred in the cell.

Given the outcomes derived from the experiments of various electrolyte formulations in FIGS. 1B-1K, the FoF2 formulation is contemplated as the chosen electrolyte for the present disclosure. FIG. 2 illustrates a schematic view of a battery cell 10 according to one or more aspects of the disclosure. The battery cell 10 has a positive electrode 12, a negative electrode 14, and a separator 16 saturated by an electrolyte 18. The positive electrode 12 has a current collector 20, which may be metal, and a positive active material layer 22 on the current collector 20. The negative electrode 14 may be made of a graphite-based material or any other suitable negative electrode material. The electrolyte 18 saturating the positive electrode 12, negative electrode 14, and separator 16 includes lithium hexafluorophosphate and lithium bis(fluorosulfonyl)imide in a ratio of 0.8M to 0.2M and a 7 wt. % fluorinated phosphazene additive all dissolved in a solvent mixture of ethylene carbonate, ethyl methyl carbonate, and sulfolane in a 25/73/2 volume ratio. The electrolyte 18 permeates a surface of the positive active material layer 22 and suppresses electrochemical oxidation of the positive active material layer 22 during electrochemical cycling of the positive active material layer 22.

The positive active material layer 22 is made oxidation-resistant by the stabilization of disassociated lithium ions from the lithium bis(fluorosulfonyl)imide through complexation with fluorinated phosphazene and sulfolane molecules. Further, this oxidation resistance may be formed by stabilizing lithium ions liberated from the lithium bis(fluorosulfonyl)imide through solvation with fluorinated phosphazene and sulfolane molecules. The electrolyte 18 may also include fluoroethylene carbonate at 1 wt. %, vinylene carbonate at 0.5 wt. %, propylene sulfite at 0.5 wt. %, propylene sulfone at 0.3 wt. %, ethyl sulfate anhydride at 0.5 wt. %, and lithium difluoro(oxalato)phosphate at 1 wt. %. These additives to the electrolyte 18 may be included individually or in combination resulting in a direct current impedance of the battery cell 10, for a given state of charge, that is less than a direct current impedance of an otherwise same battery cell without the fluorinated phosphazene additive.

FIG. 3 illustrates a schematic view of the positive electrode 12 according to one or more aspects of the disclosure. The positive electrode 12 includes the current collector 20 and the active material layer 22 deposited on the current collector 20. The electrolyte 18 includes lithium hexafluorophosphate and lithium bis(fluorosulfonyl)imide in a ratio of 0.8M to 0.2M and a 7 wt. % fluorinated phosphazene additive all dissolved in a solvent of ethylene carbonate, ethyl methyl carbonate, and sulfolane in a 25/73/2 volume ratio. The electrolyte 18 saturates the active layer 22 on the current collector 20.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to strength, durability, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. An electrode assembly comprising:
a current collector;
a positive active material layer on the current collector; and
an electrolyte, including lithium hexafluorophosphate and lithium bis(fluorosulfonyl)imide in a ratio of 0.8M to 0.2M and a 7 wt. % fluorinated phosphazene additive dissolved in a solvent of ethylene carbonate, ethyl methyl carbonate, and sulfolane in a 25/73/2 volume ratio, permeating a surface of the positive active material layer and configured to suppress electrochemical oxidation of the positive active material layer during electrochemical cycling of the positive active material layer.

2. The electrode assembly of claim 1 wherein the electrolyte also includes fluoroethylene carbonate at 1 wt. %.

3. The electrode assembly of claim 1 wherein the electrolyte also includes vinylene carbonate at 0.5 wt. %.

4. The electrode assembly of claim 1 wherein the electrolyte also includes propylene sulfite at 0.5 wt. %.

5. The electrode assembly of claim 1 wherein the electrolyte also includes propylene sulfone at 0.3 wt %.

6. The electrode assembly of claim 1 wherein the electrolyte also includes ethyl sulfate anhydride at 0.5 wt. %.

7. The electrode assembly of claim 1 wherein the electrolyte also includes lithium difluoro(oxalato)phosphate at 1 wt. %.

8. The electrode assembly of claim 1 wherein the electrolyte also includes fluoroethylene carbonate at 1 wt. %, vinylene carbonate at 0.5 wt. %, propylene sulfite at 0.5 wt. %, propylene sulfone at 0.3 wt. %, ethyl sulfate anhydride at 0.5 wt. %, and lithium difluoro(oxalato)phosphate at 1 wt. %.

9. A battery cell comprising:
a negative electrode;
a positive electrode; and
an electrolyte, including lithium hexafluorophosphate and lithium bis(fluorosulfonyl)imide in a ratio of 0.8M to 0.2M and a 7 wt. % fluorinated phosphazene additive all dissolved in a solvent of ethylene carbonate, ethyl methyl carbonate, and sulfolane, saturating the negative and positive electrodes such that disassociated lithium ions from the lithium bis(fluorosulfonyl)imide are stabilized by complexation with fluorinated phosphazene and sulfolane molecules to mitigate electrochemical oxidation of the positive electrode.

10. The battery cell of claim 9 wherein the electrolyte also includes fluoroethylene carbonate at 1 wt. %.

11. The battery cell of claim 9 wherein the electrolyte also includes vinylene carbonate at 0.5 wt. %.

12. The battery cell of claim 9 wherein the electrolyte also includes propylene sulfite at 0.5 wt. %.

13. The battery cell of claim 9 wherein the electrolyte also includes propylene sulfone at 0.3 wt. %.

14. The battery cell of claim 9 wherein the electrolyte also includes ethyl sulfate anhydride at 0.5 wt. %.

15. The battery cell of claim 9 wherein the electrolyte also contains lithium difluoro(oxalato)phosphate at 1 wt. %.

16. The battery cell of claim 9 wherein the electrolyte also includes fluoroethylene carbonate at 1 wt. %, vinylene carbonate at 0.5 wt. %, propylene sulfite at 0.5 wt. %, propylene sulfone at 0.3 wt. %, ethyl sulfate anhydride at 0.5 wt. %, and lithium difluoro(oxalato)phosphate at 1 wt. %.

17. A battery cell comprising:
a negative electrode;
a positive electrode; and
an electrolyte, including lithium hexafluorophosphate and lithium bis(fluorosulfonyl)imide and a fluorinated phosphazene additive all dissolved in a solvent of ethylene carbonate, ethyl methyl carbonate, and sulfolane, saturating the negative and positive electrodes such that lithium ions liberated from the lithium bis(fluorosulfonyl)imide are stabilized by solvation with fluorinated phosphazene and sulfolane molecules resulting in a direct current impedance of the battery cell, for a given state of charge, being less than a direct current impedance of an otherwise same battery cell without the fluorinated phosphazene additive.

18. The battery cell of claim 17 wherein a ratio of the lithium hexafluorophosphate to lithium bis(fluorosulfonyl)imide is 0.8M to 0.2M.

19. The battery cell of claim 17 wherein the solvent of ethylene carbonate, ethyl methyl carbonate, and sulfolane has a volume ratio of 25/73/2.

20. The battery cell of claim 17 wherein the electrolyte includes fluorinated phosphazene at 7 wt. %, fluoroethylene carbonate at 1 wt. %, vinylene carbonate at 0.5 wt. %, propylene sulfite at 0.5 wt. %, propylene sulfone at 0.3 wt. %, ethyl sulfate anhydride at 0.5 wt. %, and lithium difluoro(oxalato)phosphate at 1 wt. %.
